(19) United States
(12) Patent Application Publication
(10) Pub. No.: US 2016/0207192 A1
(43) Pub. Date: Jul. 21, 2016

(54) FIELD CONE COLLECTOR

(71) Applicant: Pro Performance Sports, L.L.C., Carlsbad, CA (US)

(72) Inventors: Allen Keith Holland, Carlsbad, CA (US); Kash Oris Bell, Carlsbad, CA (US)

(21) Appl. No.: 14/597,526

(22) Filed: Jan. 15, 2015

(51) Int. Cl. B25J 1/04

(52) U.S. Cl. CPC B25J 1/04

(57) ABSTRACT

A field cone collector includes a tube attached to a handle. A pair of arms is pivotally supported at a lower end of the tube. A spring urges the arms into a first position wherein an end of each arm projects out of the tube. A linkage within the tube extends from the pair of arms to an upper end of the tube, optionally to a sliding trigger. Actuation of the linkage moves the arms into a second position wherein the arms are withdrawn towards or into the tube. A field cone may be collected by pushing the lower end of the tube through an opening in the field cone. The arms momentarily move inwardly as they pass through the opening, and then move back to the first or projecting position to hold the field cone onto the tube.

### BACKGROUND OF THE INVENTION

Field cones are widely used in athletic training. Generally, a field cone has a cone-shaped vertical section joined to a flat, round or square base, similar to, but smaller than, a traffic cone. Field cones are often made of brightly colored rubber or plastic, to enhance visibility. Depending on the sport and training exercise, field cones may be set up in lines or patterns on a field, to indicate starting and stopping positions, directions of movement, sidelines, goals or goal lines, defenders, etc. Collecting field cones can be a tedious and strenuous chore, as it requires repeated kneeling or bending over to pick up each field cone. Accordingly, there is a need for improved field cone collection techniques.

### SUMMARY OF THE INVENTION

A field cone collector includes a tube attached to a handle. A pair of arms is pivotally supported at a lower end of the tube. A spring urges the arms into a first position wherein an end of each arm projects out of the tube. A linkage within the tube extends from the pair of arms to an upper end of the tube, optionally to a sliding trigger. Actuation of the linkage moves the arms into a second position wherein the arms are withdrawn towards or into the tube. A field cone may be collected by pushing the lower end of the tube through an opening in the field cone. The arms momentarily move inwardly as they pass through the opening, and then move back to the first or projecting position to hold the field cone onto the tube. Multiple field cones may be collected without bending over or kneeling to pick them up off of the ground. The field cones may be released by actuating the linkage.

### BRIEF DESCRIPTION OF THE DRAWINGS

FIG. 1 is a top, front and left side perspective view of a field cone collector.

FIG. 2 is an enlarged view of the top end of the field cone collector as shown in FIG. 1.

FIG. 3 is an enlarged view of the bottom end of the field cone collector as shown in FIG. 1.

FIG. 4 is an exploded perspective view of the top end of the field cone collector.

FIG. 5 is an exploded perspective view of the internal components at the bottom end of the tube of the field cone collector.

FIG. 6 is a perspective view of one of the arms shown in FIG. 5.

FIG. 7 is a perspective view of the field cone collector of FIG. 1 collecting a field cone.

FIG. 8 is a perspective view of the field cone collector of FIG. 1 collecting multiple field cones.

FIG. 9 is a top perspective view of a field cone.

FIG. 10 is a section view of the field cone shown in FIG. 9.

### DETAILED DESCRIPTION

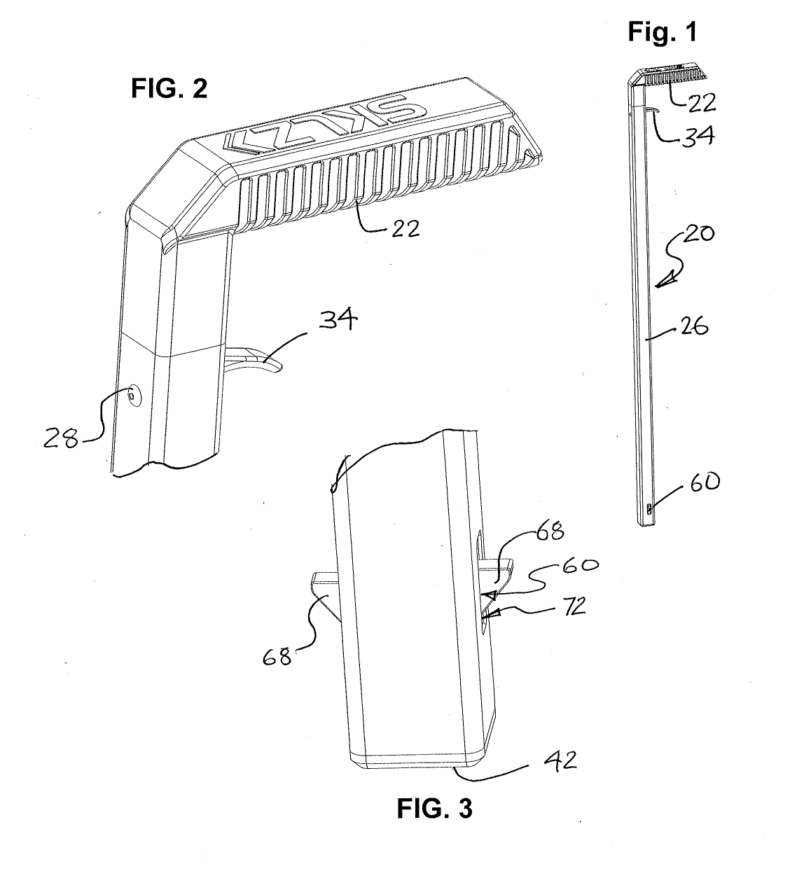

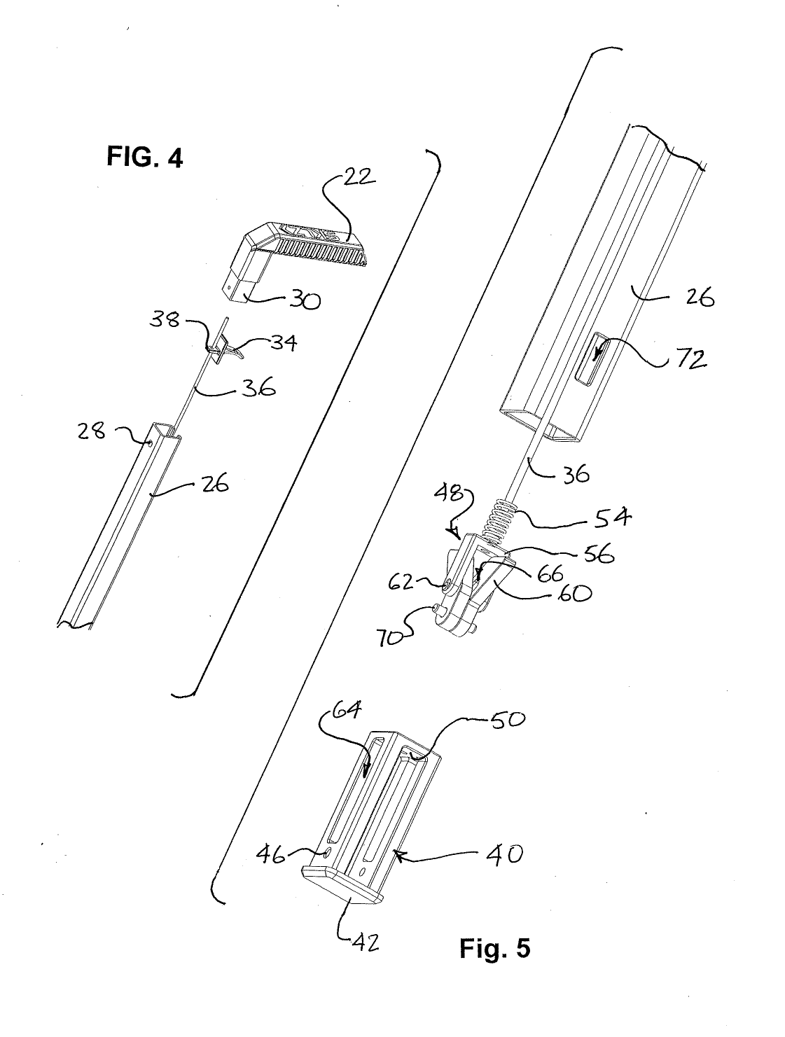

As shown in FIGS. 1, 2 and 4, a field cone collector 20 includes a handle 22 attached to a tube 26, optionally via a rivet 28 through a sidewall of the tube 26. As shown in FIG. 4, the handle 22 may be provided with a grip section perpendicular to a tube section 30 adapted to fit into an open upper end of the tube 26. A trigger 34 may be provided and slide in a trigger slot 24 in the tube 26. The trigger 34 is attached to a rod 36 optionally via a bushing 38, so that pulling up on the trigger 34 pulls the rod 36 up. The bushing may optionally allow the rod 36 to move up without moving the trigger 34. The rod 36 may be replaced by a flexible pulling element, such as a wire or cord.

Turning to FIG. 5, a frame 40 is inserted into the bottom open end of the tube 26. An end cap 42 of the frame 40 may close off the bottom end of the tube. The frame 40 may be secured into the tube 26 via a rivet or press fit. An arm mechanism 48 is positioned within the frame 40. The arm mechanism 48 has arms 60 biased into an out position by a spring 54. Pulling up on the trigger 34 moves the arms to an in position.

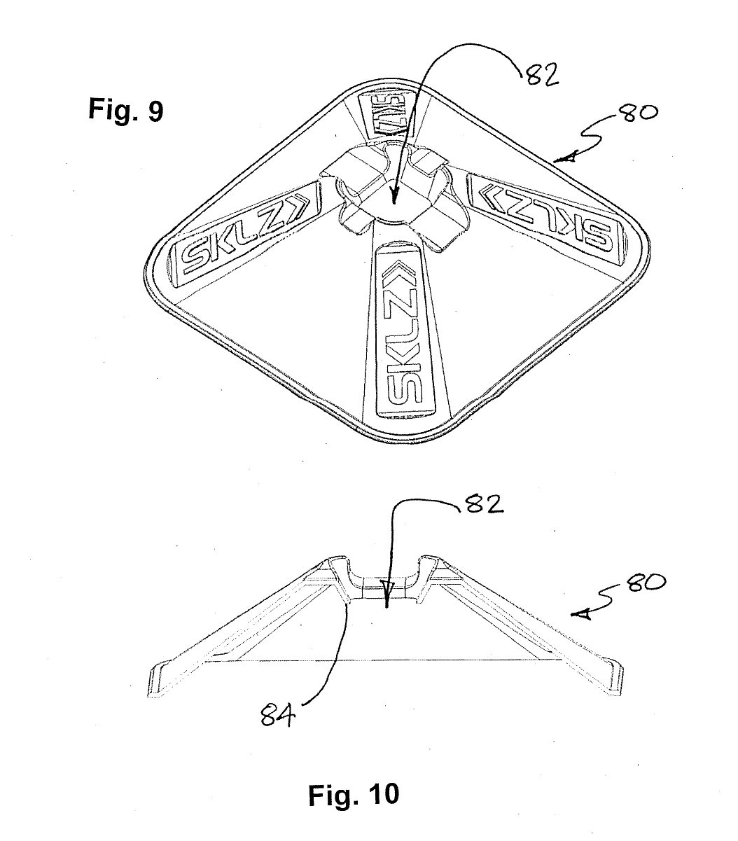

Referring momentarily to FIGS. 7-10, the cone collector 20 operates by inserting the bottom end of the tube 26 through an opening 82 in a field cone 80. During this movement, the arms are momentarily deflected inwardly to the in position, and then spring outwardly after they clear the opening back to the out position. With the arms in the out position, the field cone 80 is retained onto the tube 26. The field cone 80 may have tapered lead in surfaces 86 to guide the tube into the cone opening. 82. The dimensions of the cone opening 82 are only nominally greater than the tube, to prevent field cones 80 from rotating on the tube. As a result, the field cones are held in alignment as shown in FIG. 10, allowing the tube to hold a large number of field cones.

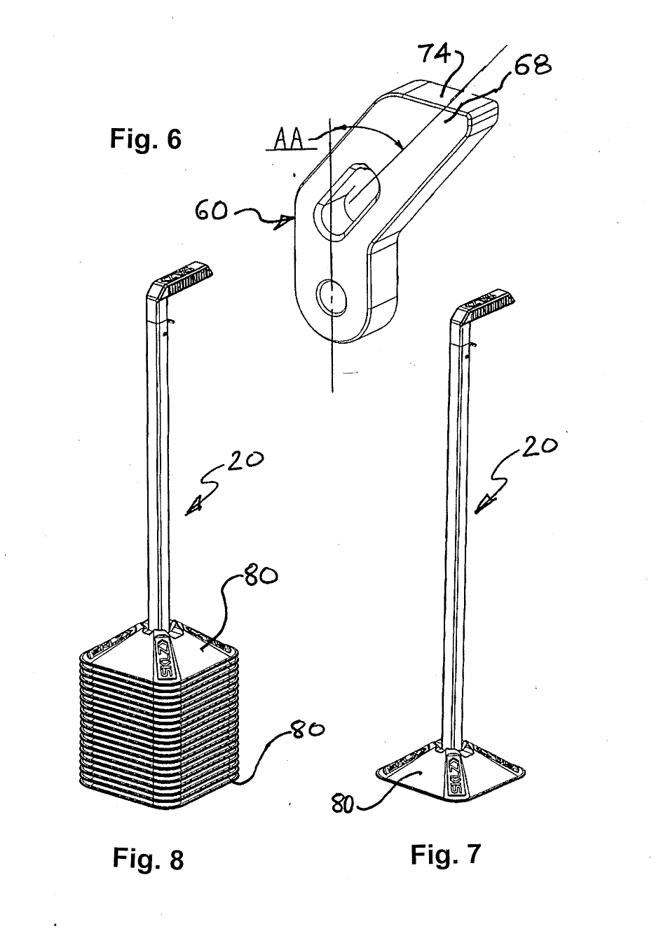

Various types of arm mechanism may be used. In the example shown in FIG. 5, the arm mechanism 48 includes first and second arms 60 pivotally mounted on a frame pin 70 supported in holes 46 at a lower end of the frame 40. The rod 36 is attached to a clevis 56 having an arm pin 62 extending through a pin slot 66 in each arm. The spring 54 is positioned between the clevis 56 and a top plate 50 of the frame 40, so that the spring 54 exerts a downward force on the clevis 56 and the arm pin 62. As shown in FIG. 6, each arm 60 has a pin slot 66 oriented at an angle AA relative to the axis of the rod 36. Angle AA is typically about 35 to 55 degrees. The downward force of the arm pin 62 holds the arms 60 in the out position. In the out position, the outer ends 68 of the arms extend out of opposite sides of the tube 26. Also as shown in FIGS. 6 and 10, the outer end 68 of each arm may have a flat top surface 74 for engaging an inner down facing surface or edge 84 of the cone 80 around the cone opening 82, as shown in FIG. 10.

The arms 60 may be replaced by equivalents such as pins or rods, plates, fingers, etc., that may be moved inwardly against spring force, as they pass through the cone opening. Although the tube 26 in the example shown is substantially square, the tube may also be triangular or another polygonal shape matching the size and shape of the cone opening. A round tube may be used with conical cones.

The cone collector 20 may be used as described above relative to FIG. 7. Referring to FIG. 8, multiple cones 80 may be sequentially collected by repeating the cone collecting steps described above, with the collected cones stacking up on the tube 26. FIG. 8 shows 20 cones collected. As the tube may generally have a length of about 110 cm, the user can collect cones without bending over or kneeling. The arm mechanism 48 acts to automatically allow the bottom end of the tube to pass through the cone opening, and then hold the cone onto the tube.

The trigger 34 may be used to release the cones from the tube 26, and need not be used during cone collecting. Pulling up on the trigger 34 pulls the rod 36 up. This in turn the clevis 56 and the arm pin 62 up, causing the arms 60 to pivot to an in position, where the arms are withdrawn into the tube, or project out only slightly. The cones may then be freely removed from the tube.

Other forms of triggers may be used, for example a pivoting trigger. Alternatively the trigger may be omitted entirely and the rod may be extended out of the tube, where it can be actuated directly. The rod may optionally be replaced by a cord or wire connected to the clevis.

Thus, a novel field cone collector has been shown and described. Various changes and substitutions may of course be made without departing from the spirit and scope of the invention. The invention, therefore, should not be limited except by the following claims and their equivalents.

1. A field cone collector, comprising:
a handle;
a tube attached to the handle;
a pair of arms pivotally supported at a lower end of the tube;
a spring urging the arms into a first position wherein an end of each arm projects out of the tube by a first dimension; and
a linkage within the tube extending from the pair of arms to an upper end of the tube, with actuation of the linkage moving the arms into a second position wherein the ends of the arm are withdrawn into the tube, or extend out of the tube by a second dimension less than the first dimension.

2. The field cone collector of claim 1 further comprising a handle attached perpendicularly to the upper end of the tube.

3. The field cone collector of claim 1 with the linkage including a rod linked to a sliding trigger at the upper end of the tube, with the rod linked to an arm pin extending through arm slot in each arm.

4. The field cone collector of claim 3 with at least part of the arm slot in each arm oriented at an acute angle to the rod.

5. The field cone collector of claim 3 further including a frame inside of the tube at the lower end of the tube, and a frame pin extending through a frame pin hole in each arm, and the frame pin supported on the frame.

6. The field cone collector of claim 5 with a lower end of the rod attached to a clevis within the frame, and the spring positioned between a top of the frame and the clevis, and with the arm pin extending through the clevis.

7. The field cone collector of claim 5 further including a frame arm slot on opposite sides of the frame, and a tube arm slot on opposite sides of the lower end of the tube, and with frame arm slots aligned with the tube arm slots, to allow an outer end of each arm to move to the first position and to the second position.

8. The field cone collector of claim 5 with the frame including an end cap forming a bottom surface of the tube.

9. The field cone collector of claim 1 with each arm having a second section joined to a first section an acute angle, and with the arm slot in the second section and a pin opening in the first section.

10. The field cone collector of claim 1 with the tube comprising a square shape with rounded corners.

11. The field cone collector of claim 1 with the tube having a length of 90 to 140 cm.

12. The field cone collector of claim 1 with each arm having a flat top surface.

13. A field cone collector, comprising:
a tube attached substantially perpendicularly to a handle;
a pair of arms pivotally supported at a lower end of the tube;
a spring urging the arms into a first position wherein an end of each arm projects out of the tube by a first dimension;
a rod inside of the tube and linked to a sliding trigger at an upper end of the tube, with the rod linked to an arm pin extending through arm slot in each arm, with upward movement of the sliding trigger pulling the rod and moving the arms into a second position wherein the arms are withdrawn into the tube or are flush with an outer surface of the tube.

14. The field cone collector of claim 13 with at least part of the arm slot in each arm oriented at an acute angle to the rod.

15. The field cone collector of claim 13 further including:
a frame inside of the tube at the lower end of the tube;
a frame pin extending through a frame pin hole in each arm, and the frame pin supported on the frame; and
a lower end of the rod attached to a clevis within the frame, and the spring positioned between a top of the frame and the clevis, and with the arm pin extending through the clevis.

16. The field cone collector of claim 1 with the linkage comprising a flexible cable attached to a clevis having a pin extending through a slot in each arm.
